(19) United States
(12) Patent Application Publication
(10) Pub. No.: US 2024/0344972 A1
(43) Pub. Date: Oct. 17, 2024

(54) COMPACT STANDOFF QUANTIFIED GAS PLUME VISUALIZATION SYSTEM

(71) Applicant: Physical Sciences Inc., Andover, MA (US)

(72) Inventors: SHIN-JUH CHEN, Arlington, MA (US); NICHOLAS F. AUBUT, Raymond, NH (US); MICHAEL B. FRISH, Medford, MA (US); RICHARD T. WAINNER, Somerville, MA (US)

(73) Assignee: Physical Sciences Inc., Andover, MA (US)

(21) Appl. No.: 18/633,848

(22) Filed: Apr. 12, 2024

Related U.S. Application Data
(60) Provisional application No. 63/495,860, filed on Apr. 13, 2023.

(51) Int. Cl. G01N 21/17

(52) U.S. Cl. CPC G01N 21/17

(57) ABSTRACT

A handheld gas detector comprising a housing including therein a laser beam source for outputting a laser beam, a microelectromechanical mirror in the path of the laser beam and actuatable in one or two angular directions that reflects the laser beam towards a target remote from the housing, a controller configured to actuate the microelectromechanical mirror to direct the reflected laser beam to a predetermined pattern of locations on the target, a photodetector for detecting backscattered laser energy from the target, and a processing subsystem configured to process outputs of the photodetector at selected locations of the pattern. The processed photodetector outputs are utilized to render a visible depiction of a gas plume on a display screen.

### CROSS-REFERENCE TO RELATED APPLICATIONS

This application claims the benefit of U.S. Provisional Application Ser. No. 63/495,860, filed on Apr. 13, 2023, entitled “Handheld Gas Detector.” Applicant incorporates by reference herein Application Ser. No. 63/495,860 in its entirety.

### STATEMENT REGARDING FEDERALLY SPONSORED RESEARCH OR DEVELOPMENT

This invention was made with U.S. Government support under Department of Energy award DE-SC0015779, National Institutes of Health Awards R43OH011711-01-00 and R44OH011711-01-00. The Government may have certain rights in the subject invention.

### BACKGROUND OF THE INVENTION

### 1. Field of the Invention

The invention relates generally to gas leak detection, and more particularly to a method and handheld apparatus for remotely detecting a gas leak, rendering quantified depictions of the gas plume and quantifying the gas emission rate.

### 2. Description of the Related Art

Different types of gases have unique light absorption characteristics. In the electromagnetic spectrum, gas molecules absorb light at specific colors (“absorption lines”) as shown in FIG. 1. Each absorption line has a linestrength. The linestrength determines the fraction of light power that a gas absorbs (the “absorbance”) from a beam of light transiting a length of gas (e.g., meters) at some concentration (e.g., parts-per-million, ppm).

Lasers are used as infrared light sources to provide highly sensitive gas detectors sensitive to concentrations as low as ˜10 ppb for methane with sub-second response and little cross-sensitivity to gases other than the target gas.

The HITRAN (acronym for High Resolution Transmission) molecular spectroscopic database plots relative absorption versus wavelength for numerous gases. FIG. 1 additionally shows a section of a spectrum highlighting methane absorption lines that do not overlay other absorption lines. These methane absorption lines offer the opportunity to measure the absorbance by methane of a laser beam having a wavelength corresponding to the absorption line free of interference from other gases.

Various methods are known for detecting gas leaks. Some utilize laser beams that pass through the leak cloud. Some require either: 1) manually scanning the laser beam about a target surface, or 2) mechanically scanning the laser beam using large and bulky equipment, and/or 3) large and bulky computational equipment. As a result, detecting gas leaks onsite may be difficult and cumbersome. Exemplary gas detection systems include U.S. Pat. Nos. 4,555,627; 6,690,472; 7,965,391; 10,371,627; 10,948,404; and 11,143,572 and U.S. Patent Publication Nos. 2005/0053104; and 2009/0159798 all incorporated herein by this reference.

Certain gas analyzers use tunable diode laser absorption spectroscopy (TDLAS) and rely on well-known spectroscopic principles and are often coupled with sensitive detection techniques and advanced diode lasers. FIG. 2 depicts the basics of a TDLAS sensor system for measuring absorbance. The system incorporates a laser that is continually tuned over time to repetitively scan its wavelength across the bandwidth of a specific target analyte gas absorption line unique to the target analyte gas. Upon transmitting the laser beam through a path bearing the target gas, the beam is attenuated according to the Beer-Lambert relation as described in Publ. No. US 2023/0107797. The received signal is processed to deduce absorbance, from which the product of path length×(times) concentration (ppm-m) may be calculated.

U.S. Pat. No. 7,075,653, assigned to Heath Consultants Inc., discloses a laser methane detector using backscatter TDLAS and wavelength-modulation spectroscopy (WMS). The laser methane detector comprises a tunable diode laser, an optical detector, and associated detection circuitry. The tunable diode laser beam is transmitted onto a distant topographic target. A portion of the laser light is reflected or backscattered by the target and returns to the optical detector which provides a measurable electrical signal output in response. The laser has a specific design wavelength (e.g., 1.65 μm) corresponding to an absorption line of methane chosen to optimize the sensitivity to methane gas while free of interfering absorption from molecules of other gases. The laser's fast tuning capability is exploited to rapidly and repeatedly scan the wavelength across the gas absorption line. While this scanning occurs, the fraction of emitted laser power that is transmitted through the gas mixture and reflected back to the instrument is received and measured by the optical detector. When the wavelength is tuned outside of the narrow characteristic absorption linewidth (“off-line”), the received light is equal to or greater than when it falls within the narrow absorption linewidth (“on-line”). Measurement of the relative amplitudes of off-line to on-line reception yields a precise and highly sensitive measure of the concentration of the methane gas along the path transited by the laser beam. The collected light is converted to an electrical signal, which is processed so that methane column density (the methane concentration integrated over the beam length) can be reported, commonly in parts per million meters (ppm·m). Typically, the laser methane detector rapidly processes discreet measurements at a refresh rate, e.g., of 10 Hz.

There exists a problem of surveying, visualizing, and quantifying a natural gas leak from a standoff distance, in real time and unaffected by background temperature variations with a relatively inexpensive handheld device.

### BRIEF SUMMARY OF THE INVENTION

A preferred embodiment of the present invention comprises a handheld standoff device using backscatter TDLAS and WMS that is easily operated to detect and quantifiably depict a gas leak plume.

A preferred embodiment of the present invention features a compact handheld gas detector which automatically scans a laser beam about a target surface and includes its own dedicated data processor(s) and controller(s) configured to detect and display a gas plume preferably superimposed over an image of the features being scanned and which may calculate and display the gas leak rate in order to facilitate prioritizing which gas leaks should be mitigated first.

Featured is an innovative scanning tool used to survey the natural gas infrastructure and which identifies, locates, and quantifiably depicts gas leak plumes and can quantify leak rates from a standoff distance. Also featured is real-time visualization of leaks that may be smaller than 1 standard cubic feet per hour (SCFH) on a display, measurement of path integrated concentration regardless of background scene, temperature, or weather conditions, which enables leak emission rate estimation for repair prioritization in a compact, lightweight, low-power, handheld configuration with easy operation, minimal training and operator-free interpretation of data.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a diagram showing how gas molecules absorb light at specific absorption lines and a section of a spectrum highlighting methane absorption lines that do not overlay other absorption lines;

FIG. 2 shows an example of tunable diode laser absorption spectroscopy;

FIG. 3 is a schematic view showing an operator using the handheld gas detector of the subject disclosure in the field;

FIG. 4A is a perspective view of an exemplary embodiment of the compact handheld gas detector shown in FIG. 3, showing the front, left side and top of the handheld gas detector;

FIG. 4B is a perspective view of the exemplary embodiment of the compact handheld gas detector shown in FIG. 4A, showing the rear and right side of the handheld gas detector;

FIG. 4C shows an optional screen display for viewing the results from the handheld gas detector;

FIG. 5 is a block diagram depicting the primary components associated with the preferred compact handheld gas detector;

FIG. 6 is an exploded view showing an example of a compact handheld gas detector;

FIG. 7 is an exploded view showing the primary components associated with a steerable mirror assembly for the handheld gas detector of FIG. 6;

FIG. 8 is a cross-sectional rendering of the steerable mirror assembly of FIG. 7;

FIG. 9 is an exploded view showing the primary components associated with the transmitter and receiver assembly for the handheld gas detector of FIG. 6;

FIG. 10 shows examples of wavelength modulation spectroscopy techniques;

FIGS. 11A-11C illustrate a leak rate measurement technique; and

FIG. 12 is a schematic view showing an implementation of leak rate measurement with laser scanning and imaging.

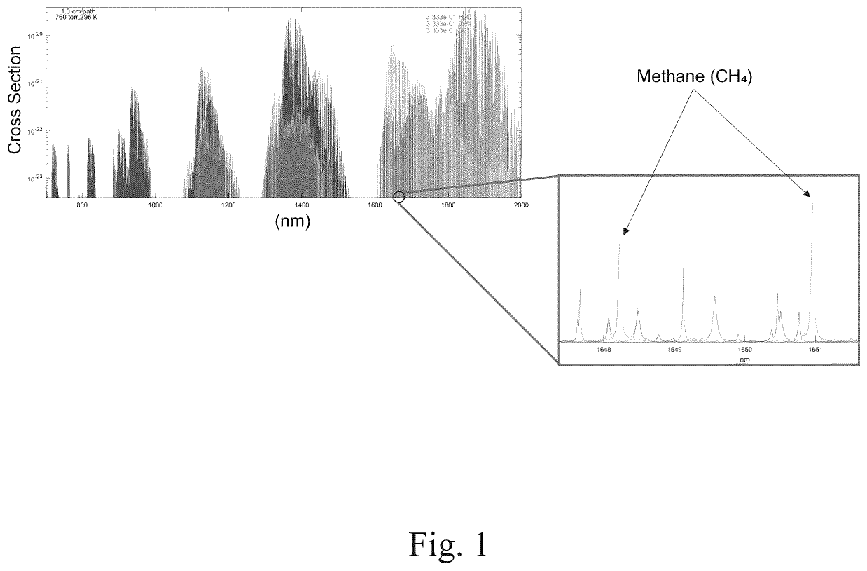

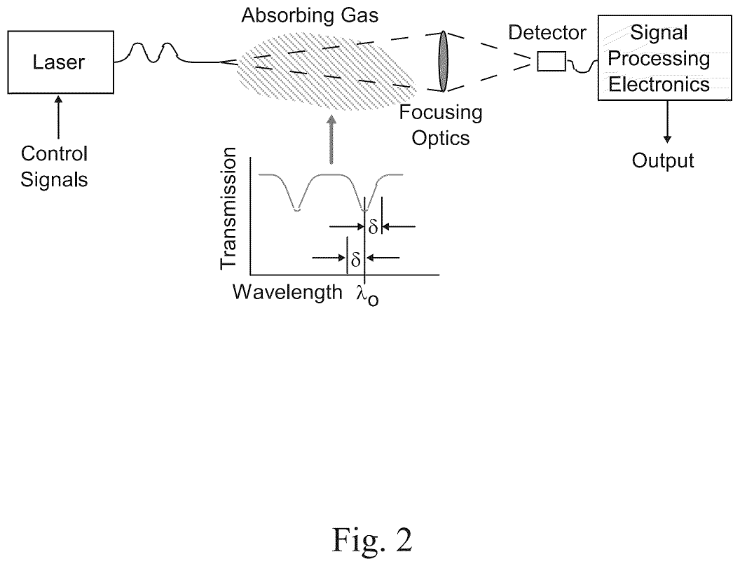

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

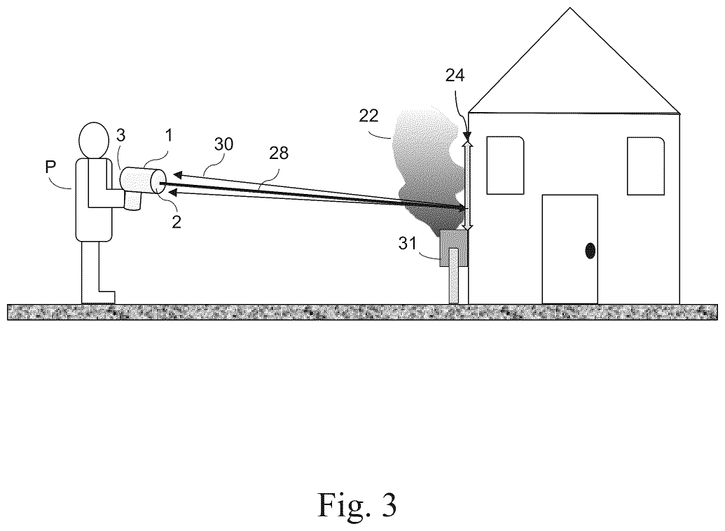

FIG. 3 is a schematic illustration of an operator P in the field using a handheld gas detector 1 according to a preferred embodiment of the present invention. The preferred system comprises the handheld gas detector 1 and an external distal backscattering surface 24 (e.g., a building wall behind a gas meter 31). The handheld gas detector 1 transmits an angularly steerable laser beam 28 directed generally towards the distal backscattering surface 24, transiting a target gas emission plume 22 if present. Laser light 30 backscattered from the backscattering surface 24 is received by the handheld gas detector 1 through a window assembly 2. The handheld gas detector 1 processes information contained in the backscattered laser light 30 and preferably presents the results on a display screen 3.

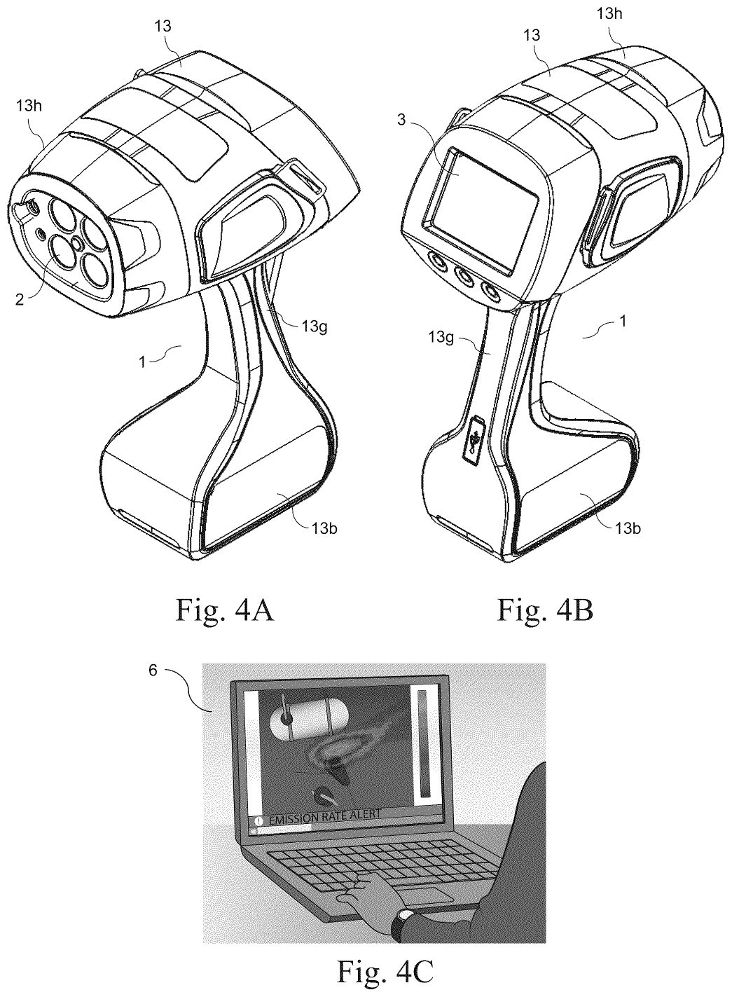

FIGS. 4A and 4B are perspective views of the exemplary embodiment of the compact handheld gas detector 1. The compact handheld gas detector 1 comprises a housing 13 having a head portion 13h, a gripping portion 13g and a base portion 13b. The window assembly 2 is on the front and the display screen 3 is on the rear of the head portion 13h. In some implementations, the display screen 3 is a touchscreen that incorporates a menu for display and operations. With reference to FIG. 4C, a tablet, cell phone or laptop computer 6 may also be utilized as the display when connected to the handheld gas detector 1.

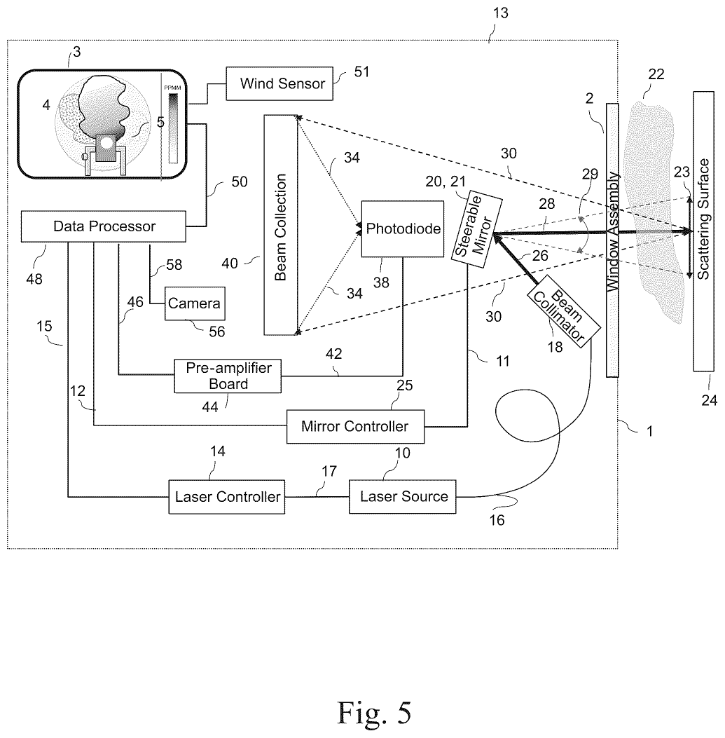

Referring to FIG. 5, the handheld gas detector 1, in one embodiment, includes a tunable laser source 10 wherein the laser emission wavelength is determined by the electrical current supplied to the laser and the temperature of the laser. The laser source package 10, may include a thermoelectric cooler coupled with a thermistor for feedback to temperature control electronics. A laser controller 14 creates electronic signals 17 that are provided to the laser source 10 to control the laser temperature and current. The laser source package 10 may also include an optical fiber output cable 16 that conducts the output laser light to a beam collimator lens 18.

The beam collimator lens 18 receives the divergent laser beam that exits the optical fiber 16 and focuses the beam 26 onto a single angularly steerable microelectromechanical mirror 20 which is preferably housed in the head portion 13h of the housing 13. To control the mirror angular position versus time, a data processor 48 creates temporally varying electrical signals 12 that are provided to a steerable mirror controller 25. The mirror controller 25 provides electrical signals 11 to the steerable mirror 20. The functionality of the mirror controller 25 and data processor 48 can be implemented as shown, implemented in a single controller/processor, or implemented across several controllers and processors.

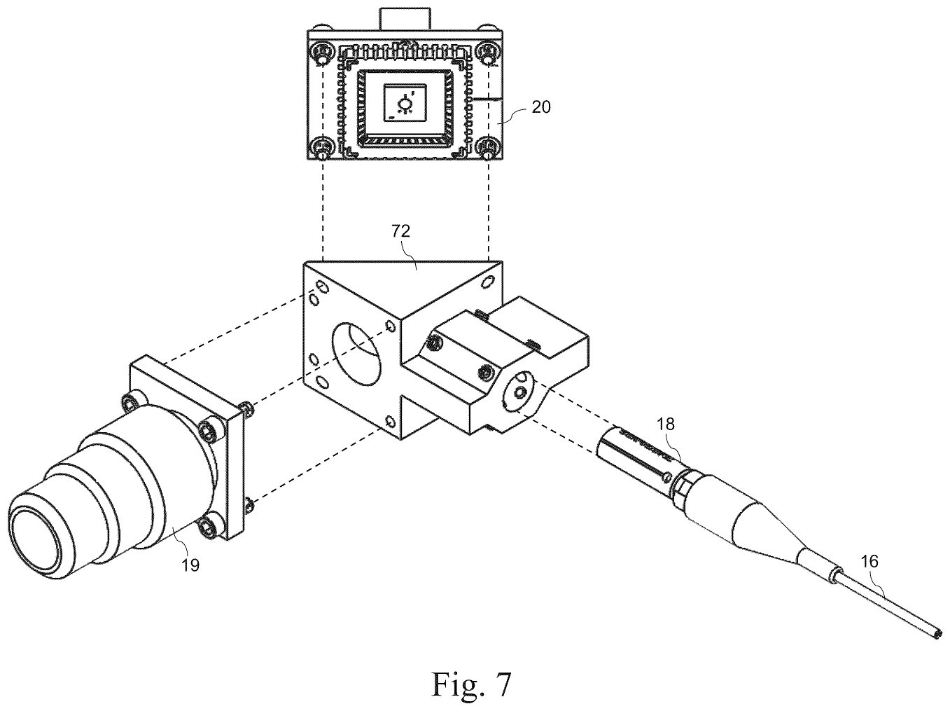

The laser beam 26 from the beam collimator lens 18 reflects from the steerable mirror 20. The reflected laser beam 28 is transmitted through a transmitter window 19 (FIG. 7) to the backscattering surface 24, transiting a target gas emission plume 22 if present. The angular direction 29 of the reflected laser beam 28 relative to the location of the steerable mirror 20 varies with time as determined by the angular position of the steerable mirror 20. The position where the reflected laser beam 28 impinges on the backscattering surface 24 thereby varies with time within the field-of-view 23 defined by the configuration and location of a receiver beam collection optical element (e.g., a focusing mirror) 40 and a photodetector 38, preferably a photodiode.

Laser light 30 backscattered from the backscattering surface 24 is received through the window assembly 2 by the beam collection optical element 40. The optical element 40 focuses the received laser power 34 onto the photodetector 38 which generates an electrical signal 42 representing the laser light power impinging on the photodetector 38. Electrical signals 42 flow to a pre-amplifier board 44 which applies gain and filtering yielding output electrical signals 46 which flow to the data processor 48. The data processor 48 also receives synchronization signals 15 from the laser controller 14. Thus, the laser controller 14 and data processor 48 operate in concert to implement a sensitive detection technique known as Wavelength Modulation Spectroscopy (WMS). Using WMS, the path-integrated target gas concentration (commonly expressed as ppm-m) is deduced at each angular direction 29 of the reflected laser beam 28. In one preferred embodiment, the data processor 48 outputs signals 50 to the display screen 3 representing ppm-m versus angular direction 29. The display screen 3 presents the output signal for each angular direction 29 as a colorized pixel located at the x-y coordinate corresponding to the angular direction 29, thus presenting a colorized map 5 of measured ppm-m vs. angular direction 29.

Still referring to FIG. 5, the handheld gas detector 1 may further include a camera 56 in the housing 13 aimed at the target. The camera 56, preferably a video camera, captures visible images 4 of the scene surrounding the field of view 23 and provides video signals 58 to the data processor 48. The data processor 48 is configured to overlay the video images 4 upon the colorized map 5 on the display screen 3. Thus, the processing subsystem creates on the display screen 3 an image of the target in addition to a depiction of the gas plume 22.

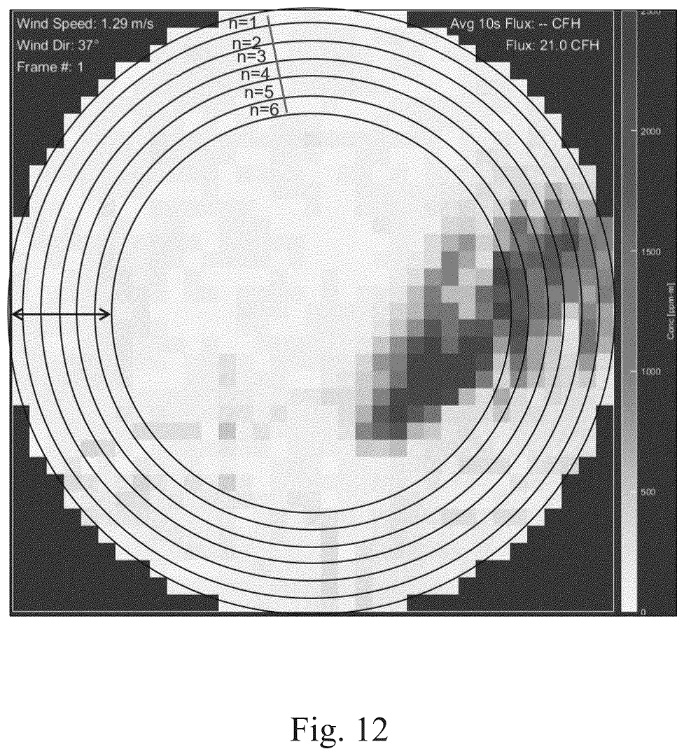

Still referring to FIG. 5, an optional wind sensor 51 provides wind speed and direction data to the data processor 48 in order to calculate the gas plume leak rate which is also displayed on the display screen 3 in some embodiments. The local wind speed and direction information may be provided by an anemometer or by analyzing emission plume images in a succession of image frames. The data processor 48 may include algorithms and firmware that utilize data embedded within the quantified gas plume depiction to deduce the target gas emission rate. In one example, the gas plume leak rate is calculated by computing a map of measured gas plume concentrations processed to extract a set of laser curtains 60 (FIG. 12) that circumscribe the plume 22 and may be paired with wind data to determine the leak rate.

Thus, one embodiment of the handheld gas detector 1 includes a housing 13 and a user interface including a display screen 3, which may be a touchscreen that accepts user inputs, and with the housing 13 including therein a laser beam source 10 for outputting a laser beam 26 and a steerable microelectromechanical mirror 20 in the path of the laser beam 26 and for directing the reflected laser beam 28 towards a target remote from the housing 13. A photodetector 38 receives backscattered laser energy 34 from the target. A mirror controller 25 is configured to actuate the steerable microelectromechanical mirror 20 to direct the laser beam 28 to a predetermined pattern of locations on the target (e.g., a spiral pattern). A processing subsystem is configured (e.g., programmed) to process an output of the photodetector 38 at each location of the pattern, and based on the processed photodetector outputs, to create on the display screen 3 a quantified depiction of a gas plume segment present at each location of the pattern.

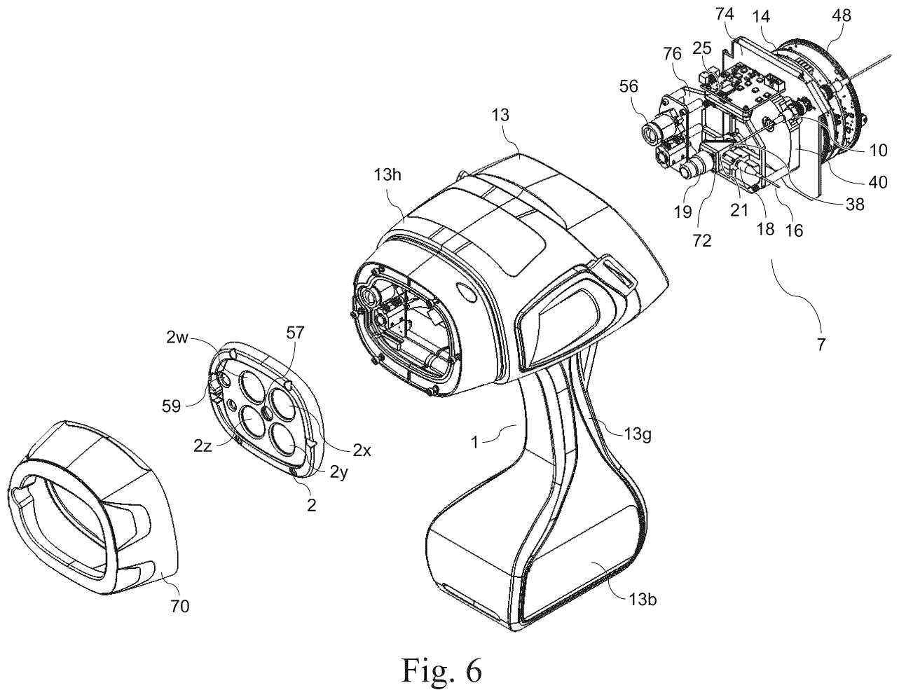

FIG. 6 shows an exploded rendering of various assemblies and components of a preferred embodiment of the compact handheld gas detector 1. The window assembly 2, a first fixture 7 and a second fixture 21 are shown removed from within the housing 13. The first fixture 7 preferably includes the data processor 48, laser source 10, laser controller 14, mirror controller 25, and camera 56. The first fixture 7 also includes the beam collection optical element 40 for directing backscattered laser energy to the photodetector 38. The beam collection optical element 40 is a concave mirror that reflects and focuses the collected laser energy onto the photodetector 38.

The second fixture 21 is attached to the first fixture 7 and includes the beam collimator 18 for the laser source 10, the single microelectromechanical mirror 20, the transmitter window 19, and the photodetector 38.

The window assembly 2 includes four individual identical receiver windows 2w, 2x, 2y and 2z. The receiver windows 2w-z pass the laser wavelength while inhibiting passage of ambient light. The window assembly 2 also includes a port 57 that accommodates the transmitter window 19 and a port 59 that accommodates the camera 56. A front cover 70 extends around the window assembly 2 and attaches to the head portion 13h of the housing 13.

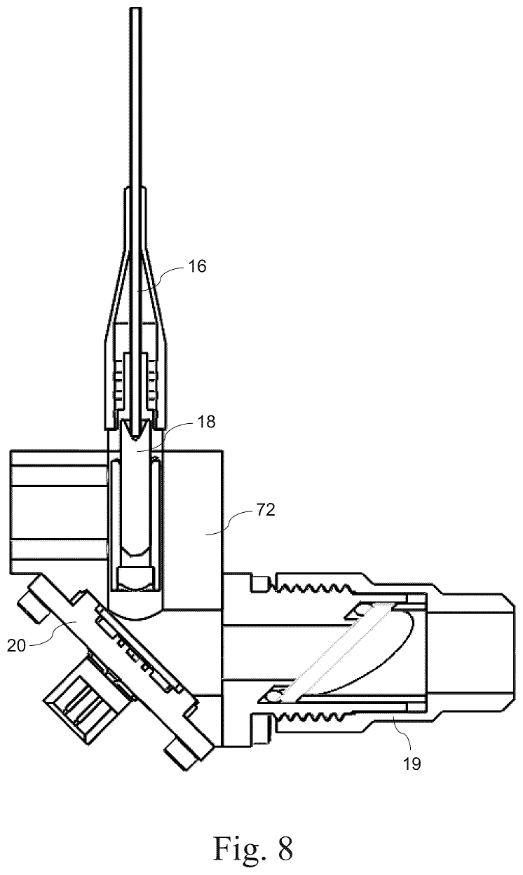

FIG. 7 is an exploded view of the steerable mirror assembly and FIG. 8 is a cross-sectional rendering of the steerable mirror assembly. The single element microelectromechanical mirror 20 mounts to a face of a mirror mount 72. Additionally, the transmitter window 19 and the beam collimator lens 18 are attached to the mirror mount 72.

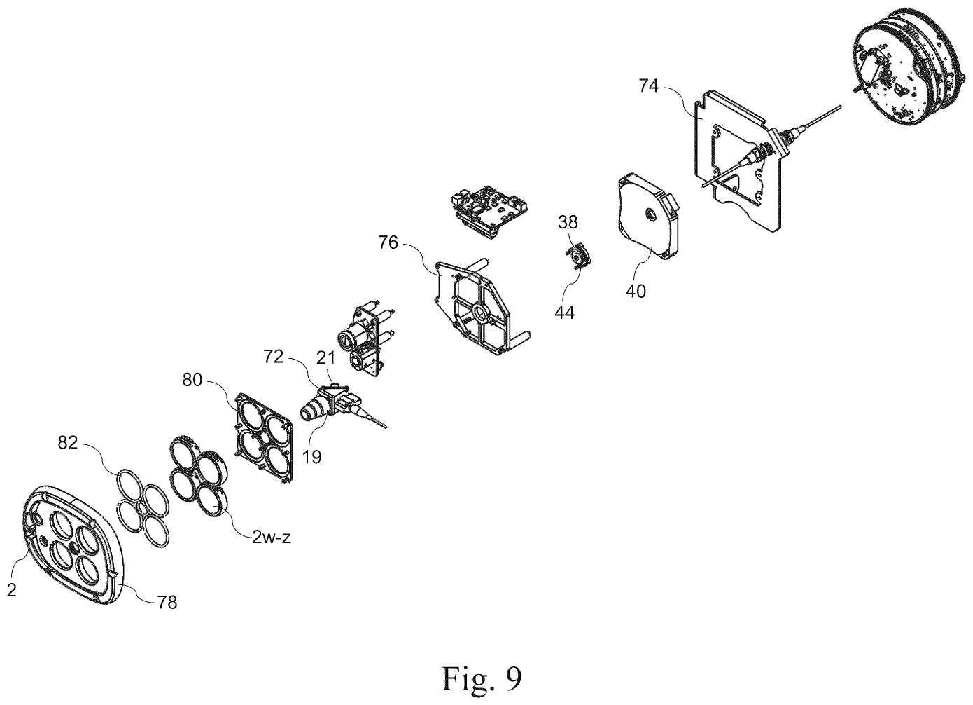

FIG. 9 is an exploded view of the transmitter and receiver assembly. Rear and medial frames 74 and 76, respectively, are provided for mounting and placement of various components, including the beam collection optical element 40, photodiode 38, pre-amplifier board 44, mirror mount 72 and camera 56 (FIG. 6). In one embodiment, the window assembly 2 includes a bezel 78, a plurality of O-ring seals 82, the receiver windows 2w-2z and a window guide 80 for maintaining proper placement and protection of the receiver windows 2w-2z.

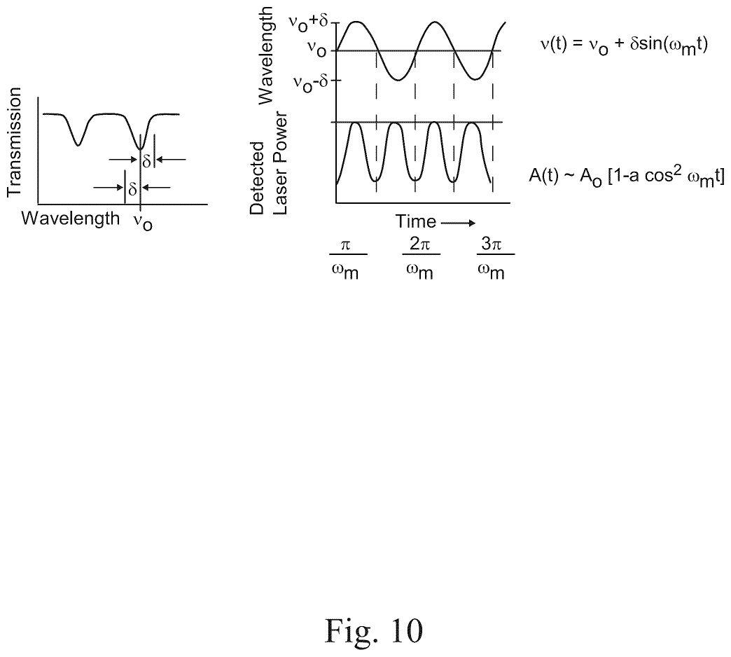

In FIG. 10, wavelength modulation spectroscopy (WMS), an implementation of TDLAS, provides very high sensitivity to small absorbance. The laser wavelength is initially “tuned” via its temperature to the center of the absorption line (vo) (FIG. 10, left). The laser wavelength is then scanned repeatedly, via its injection current, across a portion of an absorption line at frequency om (FIG. 10, top right), thus producing an amplitude modulation (AM) of the laser power received (FIG. 10, bottom right). The AM frequency is 2ωm. Lock-in amplification processing demodulates the small AM signal to yield a value of molecular concentration in the laser path.

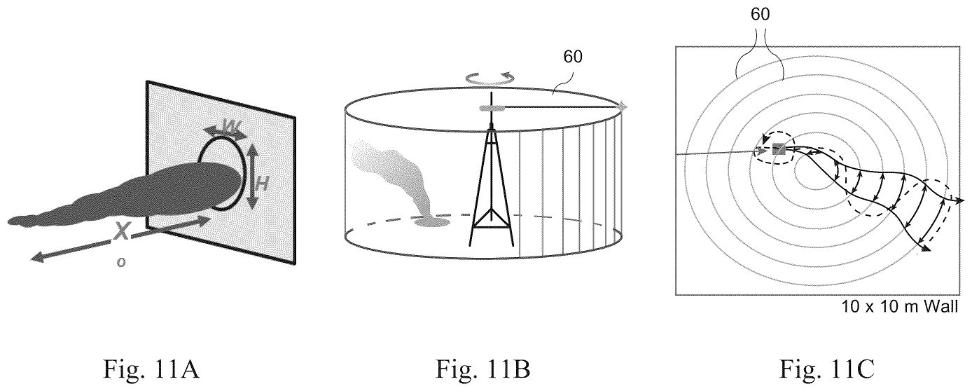

FIGS. 11A-11C show an exemplary leak rate measurement technique that is an optional feature of the handheld system. In the exemplary technique a laser beam is scanned along a surface that a gas plume crosses (flux plane) to measure ppm-m vs. position and deduce flux by integrating over position and multiplying by the wind vector (mass balance). It is one of several techniques that could be used as described in the following references:

L. M. Golston, N. F. Aubut, M. B. Frish, S. Yang, R. W. Talbot, C. Gretencord, J. McSpiritt and M. A. Zondlo, “Natural Gas Fugitive Leak Detection Using an Unmanned Aerial Vehicle: Localization and Quantification of Emission Rate,” Atmosphere 2018, 9, 333; doi: 10.3390/atmos9090333, August 2018; and

S. Yang, R. W. Talbot, M. B. Frish, L. M. Golston, N. F. Aubut, M. A. Zondlo, C. Gretencord, and J. McSpiritt, “Natural Gas Fugitive Leak Detection Using an Unmanned Aerial Vehicle: Measurement System Description and Mass Balance Approach,” Atmosphere 2018, 9, 383; doi: 10.3390/atmos9100383, October 2018.

As an example and with reference to FIG. 11B: a surface that encloses the leak source (e.g., a cylinder) is scanned creating a “laser curtain” 60. Only methane emitted from within the laser curtain 60 yields a non-zero net flux (mass balance). A set of concentric laser curtains 60 viewed from above is shown in FIG. 11C. Parts-per-million-meter (ppm-m) is measured at each point along the circumference of a curtain 60. The net methane flux flowing through the curtain is:

∫₀^{2π}v cos θ·d∫₀^{H}c dz dθ
where
   v: wind speed,
   θ: angle relative to a starting point,
   d: distance between two adjacent data points,
   z: height above curtain bottom,
   c: local methane concentration, and
   ∫₀^{H} c dz is measured.

FIG. 12 shows an implementation of leak rate measurement with laser scanning: Capture a map 5 of measured ppm-m within the field-of-view 23 thus visualizing a gas emission plume 22 if present, process the map data embedded in the output signals 50 to extract a set of laser curtains 60, provide wind information via manual keypad entry, a remote anemometer, or image processing, calculate emission rate for each laser curtain, and average several curtains, e.g., n=1-6.

The result is, in one example, a system which creates images of the path-integrated concentration of a selected target gas using backscatter tunable diode laser absorption spectroscopy (b-TDLAS) in a compact handheld lightweight package 1. The system includes a semiconductor distributed-feedback (DFB) diode laser beam source 10 that emits an output laser beam. A beam collimator 18 receives the output laser beam and directs it at a single-element microelectromechanical scanning mirror 20 (of nominally 1.2 mm diameter). The focal length of the beam collimator 18 is nominally 2 mm and the microelectromechanical scanning mirror 20 is nominally 5 mm distal from the lens 18. The microelectromechanical scanning mirror 20 reflects the laser beam 28 thus directing it onto a target from which a fraction of the laser light is reflected or backscattered 30 towards the laser source from within a field of view 23. An optical receiver 40 (nominally 2-inch diameter and 1.5 inch depth) collects the reflected or backscattered laser light 30 and directs it onto a photodetector 38.

The field of view 23 is determined by the size of the photodetector 38 that receives the reflected or backscattered laser light 30 and the magnification of the optical receiver 40. The size of the photodetector 38 is approximately 5 mm diameter.

Preferably, the b-TDLAS system utilizes Wavelength Modulation Spectroscopy to output measurements of path-integrated gas concentration at a rate of approximately 1 kHz.

In one embodiment, the microelectromechanical scanning mirror 20 may scan the laser beam 28 substantially within the field of view 23 producing a new pixel of measured path-integrated concentration approximately each millisecond. The system firmware in the data processor organizes a collection of nominally 1000 discrete pixels to form a two-dimensional colorized map 5 that may be visualized on a display 3, 6. The field-of-view 23 may include an area encompassing a region of selected target gas with path-integrated concentration locally enhanced relative to the ambient background. The locally enhanced path-integrated selected target gas concentration is due to emission from a component of a selected target gas containment or transportation system. Data analysis algorithms utilize the measured path-integrated selected target gas concentration to estimate selected target gas emission rate and estimated selected target gas emission rate is provided as an output. Such an algorithm may include a mass-balance calculation.

In a preferred implementation, the target gas may be methane or natural gas. Preferably, the laser wavelength is between 700 nm and 3500 nm. The backscattering target is usually a component of a selected target gas containment or transportation system, or part of the local topography near components of a selected target gas containment or transportation system.

In some implementations of the invention, the laser source 10 is tuned for detection of one of the gases selected from: methane (CH₄), ethane (C₂H₆), carbon dioxide (CO₂), carbon monoxide (CO), ammonia (NH₃), hydrogen sulfide (H₂S), hydrogen fluoride (HF), hydrogen chloride (HCl), ethylene oxide (EtO), and others.

In some implementations of the invention, the laser source 10 is selected from a distributed feedback laser (DFB), an interband cascade laser (ICL), a vertical-cavity surface emitting laser (VCSEL), and a quantum cascade laser (QCL).

In some implementations of the invention, the photodetector 38 is a photodiode of the type including silicon (Si), or Indium-Gallium-Arsenide (InGaAs), or Mercury-Cadmium-Telluride (MCT), or Indium-Antimonide (InSb), or others.

In some implementations of the invention, the camera 56 captures single frame images, video images, or a combination of single frame and video images.

In one embodiment of the present invention, a method for detecting, visualizing, quantifying, and recording the gas leak comprises the following steps. The tool 1 may be put in the survey mode via a user interface command to identify pockets of high gas concentrations. The tool 1 is directed such that the measurement laser beam 28 is pointed to the area of interest. Readings on the display screen 3 are monitored for path-integrated concentrations exceeding a threshold set by the user via user interface input. In some implementations, the survey mode is performed by scanning the laser beam 28 in a tight pattern over the area of interest. The pattern may be circular, random, raster-scanning, or of any other type, or using a single laser beam path directed at the target.

Upon identifying a gas leak, the tool 1 may be switched by the user via the user interface to the imaging mode to pinpoint the location of the leak. To provide best measurement sensitivity, the distance between the operator P and the leak location should be minimized to the extent permitted by physical obstacles in the field. In some implementations, the imaging mode is performed by scanning the laser beam 28 over the field of view 23 with a pattern that may be circular, random, raster-scanning, or of any other type.

An optional quantification mode measures the gas emission rate. The measurement is computed automatically for every measurement frame and reported to the display screen 3.

### REFERENCE CHARACTER INDEX

operator P

handheld gas detector 1

window assembly 2

receiver windows 2w-2z

display screen 3

visible images 4

colorized map 5

laptop computer 6

first fixture 7

laser source 10

electrical signals 11

temporally varying electrical signals 12

housing 13

base portion 13b

gripping portion 13g

head portion 13h

laser controller 14

synchronization signals 15

optical fiber output cable 16

electronic signals 17

beam collimator lens 18

transmitter window 19

single element microelectromechanical mirror 20

second fixture 21

target gas emission plume 22

field-of-view 23

backscattering surface 24

steerable mirror controller 25

laser beam 26

reflected laser beam 28

angular direction 29

backscattered laser light 30

gas meter 31

laser power 34

photodetector 38

beam collection optical element 40

electrical signal 42

pre-amplifier board 44

output electrical signal 46

data processor 48

signals 50

wind sensor 51

video camera 56

port 57

video signals 58

port 59

laser curtain 60

front cover 70

mirror mount 72

rear frame 74

medial frame 76

bezel 78

window guide 80

O-ring seals 82

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant cannot be expected to describe certain insubstantial substitutes for any claim element amended.

What is claimed is:

1. A handheld gas detector (1) comprising:
a housing (13) including therein:
a laser beam source (10) for outputting a laser beam (26);
a microelectromechanical mirror (20) in the path of the laser beam (26) and actuatable in one or two angular directions that reflects the laser beam (26) towards a target remote from the housing (13);
a controller (14) configured to actuate the microelectromechanical mirror (20) to direct the reflected laser beam (28) to a predetermined pattern of locations on the target;
a photodetector (38) for detecting backscattered laser energy from the target; and
a processing subsystem (48) configured to process outputs of the photodetector (38) at selected locations of the pattern.

2. The handheld gas detector (1) of claim 1, wherein the processed photodetector outputs are utilized to render on a display screen (3) a visible depiction of a gas plume (22).

3. The handheld gas detector (1) of claim 2, further comprises:
a video camera (56) within the housing (13), the camera aimed substantially parallel to the laser beam, and
the processing subsystem (48) creates on the display screen (3) an image of the target in addition to the visible depiction of the gas plume (22).

4. The handheld gas detector (1) of claim 1, further including a first fixture (7) in the housing (13) including the laser beam source (10) and a beam collection mirror (40) for directing backscattered laser energy to the photodetector (38).

5. The handheld gas detector (1) of claim 4, further including a second fixture (21) within the housing (13) attached to the first fixture (7) and including a beam collimator (18) for the laser beam (26), the microelectromechanical mirror (20), and the photodetector (38).

6. The handheld gas detector (1) of claim 4, in which the first fixture (7) further includes the controller (14) and processing subsystem (48).

7. The handheld gas detector (1) of claim 1, wherein the wavelength of the laser beam source (10) is tuned for detection of one of the gases selected from: methane, ethane, carbon dioxide, carbon monoxide, ammonia, hydrogen sulfide, hydrogen fluoride, hydrogen chloride, and ethylene oxide.

8. The handheld gas detector (1) of claim 1, wherein the laser beam source (10) is selected from one of the group consisting of: distributed feedback laser, interband cascade laser, vertical-cavity surface emitting laser, and quantum cascade laser.

9. The handheld gas detector (1) of claim 1, further including a receiver window (2w-2z) that passes the laser wavelength while inhibiting passage of ambient light.

10. The handheld gas detector (1) of claim 1, wherein the photodetector (38) is a photodiode of the type including one of the group consisting of: silicon, indium-gallium-arsenide, mercury-cadmium telluride, and indium-antimonide.

11. The handheld gas detector (1) of claim 1, further including an input or calculation of wind speed and direction and the processing subsystem (48) is responsive to the wind speed and direction to calculate a gas plume leak rate.

12. The handheld gas detector (1) of claim 1, further including a wind speed and direction sensor (51) and the processing subsystem (48) is responsive to the wind speed and direction sensor (51) to calculate a gas plume leak rate.

13. The handheld gas detector (1) of claim 2. wherein the display screen (3) is on the housing (13).
